(19) United States
(12) Patent Application Publication
(10) Pub. No.: US 2026/0351176 A1
(43) Pub. Date: Nov. 5, 2026

(54) DISPLAY DEVICE, ELECTRONIC DEVICE, AND DRIVING METHOD OF DISPLAY DEVICE

(71) Applicant: Samsung Display Co., Ltd., Yongin-Si (KR)

(72) Inventors: JIYOUNG LEE, Yongin-si (KR); HYUNYOUNG CHOI, Yongin-si (KR); HYUNG UK CHO, Yongin-si (KR)

(21) Appl. No.: 19/644,238

(22) Filed: Apr. 10, 2026

(30) Foreign Application Priority Data
Apr. 30, 2025 (KR) 10-2025-0057339

(51) Int. Cl. G09G 3/3233; G09G 3/3266; G09G 3/3291

(52) U.S. Cl. CPC G09G 3/3233; G09G 3/3266; G09G 3/3291; G09G 2300/043; G09G 2300/0819; G09G 2300/0852; G09G 2310/027; G09G 2310/08; G09G 2320/0233; G09G 2320/0252; G09G 2320/045

(57) ABSTRACT

A pixel of a display device includes a first transistor connected between a first drive voltage line and a second drive voltage line, a first capacitor including a first terminal configured to receive a data signal and a second terminal connected to a gate of the first transistor, a second transistor connected between the gate and a drain of the first transistor and including a gate configured to receive a first gate signal, a third transistor including a first terminal connected to the gate or the drain of the first transistor, a second terminal configured to receive a first voltage and a gate configured to receive a second gate signal, a fourth transistor connected in series with the first transistor and including a gate configured to receive a third gate signal, and a light emitting element connected in series with the first transistor and the fourth transistor.

### CROSS-REFERENCE TO RELATED APPLICATIONS

This application claims priority under 35 U.S.C. § 119 to and the benefit of Korean Patent Application No. 10-2025-0057339 filed on Apr. 30, 2025 in the Korean Intellectual Property Office, the entire contents of which are incorporated herein by reference.

### BACKGROUND

### (a) Field

The disclosure relates to a display device, an electronic device, and a method of driving the display device.

### (b) Description of the Related Art

Generally, a display device includes an array of pixels, and an image is displayed by controlling the light intensity of each pixel in accordance with provided luminance information. Among various types of display devices, a light-emitting display device has self-emitting characteristic and thus does not require a separate light source, which allows reductions in thickness and weight. Furthermore, the light-emitting display device provides several characteristics such as low power consumption, high luminance, and high response speed.

Each pixel of the light-emitting display device includes a light-emitting element and a transistor that drives it. During formation of the transistors, variations in threshold voltages of the transistors within the display device may occur. If such variations in threshold voltages arise, the transistors may cause different currents to flow in response to the same data signals, thereby degrading brightness uniformity of the displayed image.

### SUMMARY

Some embodiments may provide a display device, an electronic device, and a method of driving the display device, which compensates for variations in threshold voltages of transistors to improve brightness uniformity of a displayed image.

According to an embodiment, a display device includes a pixel, a gate driver configured to output a first gate signal, a second gate signal, and a third gate signal to the pixel, and a data driver configured to output a data signal having either a reference voltage or a data voltage to the pixel. The pixel includes a first transistor connected between a first drive voltage line configured to supply a first drive voltage and a second drive voltage line configured to supply the second drive voltage, a first capacitor including a first terminal configured to receive the data signal and a second terminal connected to a gate of the first transistor, a second transistor connected between the gate of the first transistor and a drain of the first transistor, and including a gate configured to receive the first gate signal, a third transistor including a first terminal connected to either the gate of the first transistor or the drain of the first transistor, a second terminal configured to receive a first voltage, and a gate configured to receive the second gate signal, a fourth transistor connected in series with the first transistor between the first drive voltage line and the second drive voltage line, and including a gate configured to receive the third gate signal, and a light emitting element connected in series with the first transistor and the fourth transistor between the first drive voltage line and the second drive voltage line.

The pixel may further include a second capacitor connected between the first drive voltage line and the first terminal of the first capacitor.

The pixel may further include a second capacitor connected between the first drive voltage line and the gate of the first transistor.

The pixel may further include a fifth transistor connected to the light emitting element in parallel and including a gate configured to receive a fourth gate signal.

The pixel may further include a fifth transistor connected between an anode of the light emitting element and a signal line configured to carry a second voltage, and including a gate configured to receive a fourth gate signal as a gate.

The first terminal of the third transistor may be connected to the gate of the first transistor, and the first voltage may be the data signal.

The first terminal of the third transistor may be connected to the drain of the first transistor, and the first voltage may be the data signal.

The first terminal of the third transistor may be connected to the drain of the first transistor, and the first voltage may be a voltage other than the data signal.

The pixel may further include a fifth transistor connected between a data line configured to carry the data signal and the first terminal of the first capacitor, and including a gate configured to receive a fourth gate signal.

The fourth gate signal may be the first gate signal.

The second gate signal of the pixel may be the first gate signal of another pixel.

The gate driver may be further configured to output the first gate signal having an enable level, the second gate signal having the enable level, and the third gate signal having the enable level in a first period, output the first gate signal having the enable level, the second gate signal having the disable level, and the third gate signal having the disable level in a second period, and output the first gate signal having the disable level, the second gate signal having the disable level, and the third gate signal having the enable level in a third period. The data driver may be further configured to output the data signal having the reference voltage in the first period, and output the data signal having the data voltage in the second period.

The gate driver may be further configured to output the first gate signal having the enable level, the second gate signal having the enable level, and the third gate signal having the disable level in a fourth period between the first period and the second period. The data driver may be further configured to output a data signal having the data voltage in the fourth period.

According an embodiment, an electronic device includes a processor, and a display module connected to the processor and including a pixel and a data line configured to carry a data signal having either a reference voltage or a data voltage. The pixel includes a first transistor configured to output a drive current to a drain based on a gate-to-source voltage, a capacitor including a first terminal connected to a gate of the first transistor and a second terminal configured to receive the reference voltage during an initialization period and receive the data voltage during a data writing period, a second transistor connected between the gate of the first transistor and the drain of the first transistor, and configured to diode-connect the first transistor during the data writing period, a third transistor configured to transfer a first voltage to either the gate of the first transistor or the drain of the first transistor during the initialization period, a light emitting element, and a fourth transistor configured to transfer the drive current of the first transistor to the light emitting element during a light emission period.

The first voltage may be the reference voltage transferred from the data line.

The first voltage may be a voltage supplied from a voltage line other than the data line.

The pixel may further include a fifth transistor configured to transfer a second voltage to an anode of the light emitting element during the initialization period.

The second voltage may be a drive voltage used to drive the first transistor.

The pixel may further include a fifth transistor configured to disconnect a connection between the second terminal of the capacitor and the data line during the light emission period.

According to an embodiment, a method of driving a display device, which includes a pixel including a transistor, a capacitor including a first terminal connected to a gate of the transistor, and a light emitting element, comprises initializing a second terminal of the capacitor, the gate and a drain of the transistor and an anode of the light emitting element, providing a data voltage to the second terminal of the capacitor while the transistor is diode-connected, and supplying a current of the first transistor to the light emitting element while a reference voltage is provided to the second terminal of the capacitor.

### BRIEF DESCRIPTION OF THE DRAWINGS

FIG. 1 illustrates a schematic diagram of a display device according to an embodiment.

FIG. 2 is a circuit diagram illustrating a pixel of a display device according to an embodiment.

FIG. 3 illustrates a portion of a display device according to an embodiment.

FIG. 4 illustrates a timing diagram of signals applied to a pixel of a display device according to an embodiment.

FIG. 5, FIG. 6, FIG. 7, and FIG. 8 illustrate operations of a pixel according to timing shown in FIG. 4.

FIG. 9 illustrates a timing diagram of signals applied to a pixel of a display device, according to an embodiment.

FIG. 10 is a circuit diagram illustrating a pixel of a display device according to an embodiment.

FIG. 11 is a circuit diagram illustrating a pixel of a display device according to an embodiment.

FIG. 12 illustrates a timing diagram of signals applied to a pixel shown in FIG. 11.

FIG. 13 is a circuit diagram illustrating a pixel of a display device according to an embodiment.

FIG. 14 illustrates a timing diagram of signals applied to a pixel shown in FIG. 13.

FIG. 15 is a circuit diagram illustrating a pixel of a display device according to an embodiment.

FIG. 16 is a circuit diagram illustrating a pixel of a display device according to an embodiment.

FIG. 17 is a circuit diagram illustrating a pixel of a display device according to an embodiment.

FIG. 18 is a circuit diagram illustrating a pixel of a display device according to an embodiment.

FIG. 19 is a circuit diagram illustrating a pixel of a display device according to an embodiment.

FIG. 20 illustrates a timing diagram of signals applied to a pixel shown in FIG. 19.

FIG. 21 is a block diagram illustrating an electronic device according to an embodiment.

FIG. 22 is a schematic diagram of electronic devices according to various embodiments.

### DETAILED DESCRIPTION OF THE EMBODIMENTS

In the following detailed description, only certain embodiments of the disclosure have been shown and described, simply by way of illustration. As those skilled in the art would readily appreciate, the described embodiments may be modified in various different ways without departing from the spirit or scope of the disclosure.

The drawings and description are to be regarded as illustrative in nature and not restrictive. Like reference numerals designate like elements throughout the specification. The sequence of operations or steps is not limited to the order presented in the claims or drawings unless specifically indicated otherwise. The order of operations or steps may be changed. For example, several operations or steps may be merged, a certain operation or step may be divided, and a specific operation or step may not be performed.

In the drawings, the size and thickness of each element are may be arbitrarily illustrated for ease of description, and the present disclosure is not necessarily limited to those illustrated in the drawings. In the drawings, the thicknesses of layers and areas may be enlarged for clarity. In the drawings, for ease of description, the thicknesses of some layers and areas may be exaggerated.

It should be understood that when an element such as a layer, film, region, area, or substrate is referred to as being “on” or “above” another element, it may be directly on the other element or intervening elements may also be present. In contrast, when an element is referred to as being “directly on” another element, there are no intervening elements present between the element and another element. Further, in the specification, being “above” or “on” a reference part means being positioned above or below the reference part and does not necessarily mean being positioned “above” or “on” it in the opposite direction of gravity.

As used herein, the singular forms “a” and “an” are intended to include the plural forms as well, unless the context clearly indicates otherwise. Although the terms first, second, and the like may be used herein to describe various elements, these terms are only used to distinguish one element from another element.

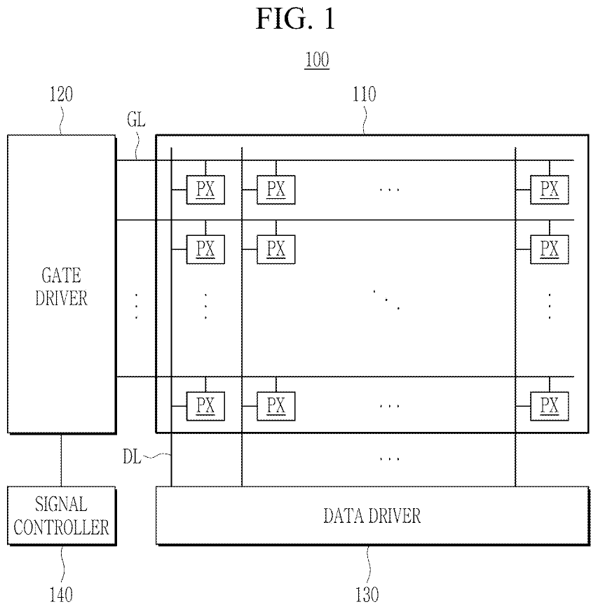

FIG. 1 is a schematic diagram illustrating a display device according to an embodiment.

Referring to FIG. 1, a display device 100 may include a display area 110 for displaying an image, a gate driver 120, a data driver 130, and a signal controller 140.

The display area 110 may include a plurality of pixels PX, and further includes a plurality of signal lines and a plurality of voltage lines connected to the plurality of pixels PX. Each pixel PX may include a plurality of transistors, a capacitor, and a light emitting element. The light emitting element may be a light emitting diode such as an organic light emitting diode (OLED). The plurality of pixels PX may be arranged in a matrix form. For example, the plurality of pixels PX are arranged along a first direction (e.g., a row direction) and a second direction (e.g., a column direction). In the display area 110, a plurality of pixels PX forming a row and arranged in a first direction may be referred to as a pixel row, and a plurality of pixels PX forming a column and arranged in a second direction may be referred to as a pixel column.

The plurality of signal lines in the display area 110 may include a plurality of gate lines GL and a plurality of data lines DL, which are connected to the plurality of pixels PX. The gate lines GL may be connected to gates of transistors included in the pixels PX to provide gate signals to the pixels PX. The data lines DL may be connected to sources or drains of the transistors included in the pixels PX to provide data signals (e.g., data voltages) to the pixels PX. The gate lines GL may extend substantially in a first direction and to a peripheral area adjacent to the display area 110 (e.g., a peripheral area adjacent to the left and/or right of the display area 110). The data lines DL may extend substantially in a second direction and to a peripheral area adjacent to the display area 110 (e.g., a peripheral area adjacent to the lower and/or upper sides of the display area 110). Each gate line GL may be connected to a plurality of pixels PX arranged in the first direction (e.g., a plurality of pixels PX arranged in the same pixel row), and each data line DL may be connected to a plurality of pixels PX arranged in the second direction (e.g., a plurality of pixels PX arranged in the same pixel column). The gate line GL connected to each pixel row may include a plurality of gate lines that are connected to gates of a plurality of transistors included in a pixel PX, respectively. The plurality of voltage lines in the display area 110 may supply a drive voltage to the pixels PX.

The gate driver 120 may be connected to the gate lines GL and may provide the gate signals to the gate lines GL. The gate driver 120 may be positioned in a peripheral area (e.g., the left or right of the display area 110). Although FIG. 1 shows an example where the gate driver 120 is positioned on the left side of the display area 110, the location of the gate driver 120 is not limited thereto. The gate driver 120 may include a gate drive circuit that generates a gate signal to be provided to each gate line GL. When a gate line GL connected to each pixel row includes a plurality of gate lines, the gate driver 120 may include a plurality of gate drive circuits that generate gate signals to be provided to the plurality of gate lines arranged in one pixel row. The gate drive circuit corresponding to each pixel row may form a stage, and in the gate driver 120, a plurality of stages may be arranged one after the other, for example in a second direction. The gate lines GL connected to each pixel row may include, for example, a select gate line used for writing a data signal and an emit gate line used for emitting the pixels.

The gate driver 120 may sequentially provide the gate signals to the plurality of gate lines GL (e.g., a plurality of select gate lines) included in the display area 110. For example, the gate signals provided to the plurality of gate lines GL may toggle the levels of the gate signals from a disable level to an enable level. Accordingly, the pixel in the pixel row connected to the select gate line through which the gate signal having the enable level is applied may store a data signal provided through the data line DL, and may emit light in response to the enable level of the gate signal applied through the emit gate line. The gate signals applied to the plurality of emit gate lines may have the enable levels at the same time, or may have the enable levels sequentially. After sequentially providing the gate signals toggling to the enable level to one group of select gate lines (e.g., odd-numbered select gate lines) among the plurality of gate lines (e.g., select gate lines) GLs, the gate driver 120 may sequentially provide the gate signals, which sequentially toggle from the disable level to the enable level, to another group of select gate lines (e.g., even numbered select gate lines) among the plurality of select gate lines.

The data driver 130 may generate data signals and provide them to the data lines DL. The data signal may be converted from a reference voltage to a data voltage representing a grayscale (or luminance).

The signal controller 140 may receive an input video signal and input control signals from an external source, and may process them to generate data signals and control signals that control operations of the gate driver 120 and the data driver 130. The signal controller 140 may be called a timing controller. The input control signals may include, for example, a vertical synchronization signal, a horizontal synchronization signal, a main clock signal, and a data enable signal. The control signals provided from the signal controller 140 to the data driver 130 may include, for example, a horizontal synchronization start signal, a clock signal, and a line latch signal, and the control signals provided from the signal controller 140 to the gate driver 120 may include, for example, a vertical synchronization start signal, an output enable signal, and a gate pulse signal.

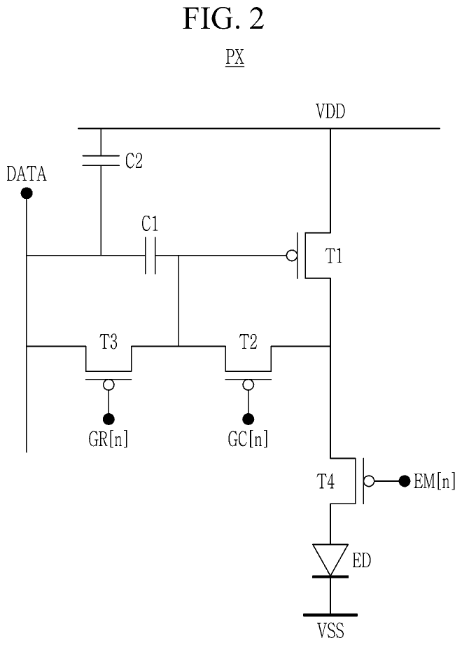

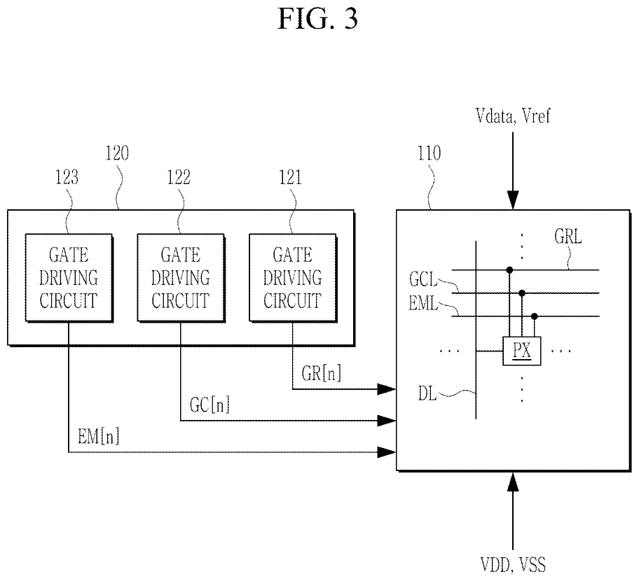

FIG. 2 is a circuit diagram illustrating a pixel of a display device according to an embodiment, and FIG. 3 illustrates a portion of a display device according to an embodiment. FIG. 2 shows an equivalent circuit of a pixel PX connected to the n-th gate signals GC[n] and GR[n], which are switched from a disable level to an enable level.

Referring to FIG. 2 and FIG. 3, a pixel PX of a display device may include a plurality of transistors T1, T2, T3, and T4, a plurality of capacitors C1 and C2, and a light emitting element ED. The pixel PX of the display device may be connected to a plurality of gate lines GRL, GCL, and EML carrying gate signals GR[n], GC[n], and EM[n], a data line DL carrying a data signal, a drive voltage line VDDL carrying a drive voltage VDD, and a drive voltage line VSSL carrying a drive voltage VSS. Each of the transistors T1 to T4 may have a first terminal, a second terminal, and a gate, and may be a p-channel transistor or an n-channel transistor. The first terminal and the second terminal may be a source or a drain depending on voltages of the first terminal and the second terminal. For example, one of the first terminal and the second terminal may be the source, and the other may be the drain. FIG. 2 shows an example where the transistors T1 to T4 are p-channel transistors, but the types of the transistors in the pixel PX are not limited thereto. If the transistor T1 is the p-channel transistor, the drive voltage VDD may be higher than the drive voltage VSS.

The gate driver 120 may include a gate drive circuit 121 that generates a gate signal GR[n] that is applied to the gate line GRL, a gate drive circuit 122 that generates a gate signal GC[n] that is applied to the gate line GCL, and a gate drive circuit 123 that generates a gate signal EM[n] that is applied to the gate line EML. The gate signals GR[n], GC[n], and EM[n] may alternately have an enable level for turning on the corresponding transistor and a disable level for turning off the corresponding transistor. In a case where the transistors T1 to T4 are the p-channel transistors, the enable level may be a low level and the disable level may be a high level. Hereafter, for convenience of explanation, the enable level is described as being the low level, and the disable level as being the high level. However, in a case where any of the transistors T1 to T4 is a n-channel transistor, the enable level for the n-channel transistor would be the high level, and the disable level for the n-channel transistor would be the low level. The data signal applied to the data line DL may selectively have a reference voltage Vref and a data voltage Vdata corresponding to grayscale (or luminance).

The first transistor (or drive transistor) T1 may be connected between the voltage line VDDL and the voltage line VSSL. For example, a first terminal (e.g., source) of the first transistor T1 may be connected to the voltage line VDDL, a gate of the first transistor T1 may be connected to the data line DL through a first capacitor C1, and a second terminal (e.g., drain) of the first transistor T1 may be connected to the voltage line VSSL through a fourth transistor T4 and a light emitting element ED. The first transistor T1 may transfer a drive current, corresponding to a voltage between the source and the gate, to the light emitting element ED through the drain. The first capacitor C1 may be connected between the data line DL and the gate of the first transistor T1, and a second capacitor C2 may be connected between the voltage line VDDL and a first terminal of the first capacitor C1 (or the data line DL). For example, the first terminal of the first capacitor C1 may be connected to the data line DL, a second terminal of the first capacitor C1 may be connected to the gate of the first transistor T1. A first terminal of the second capacitor C2 may be connected to the voltage line VDDL, and a second terminal of the second capacitor C2 may be connected to the first terminal of the first capacitor C1 (or the data line DL).

The second transistor T2 may be connected between the gate and the drain of first transistor T1 and may be configured to control diode-connection of the first transistor T1. For example, a first terminal of the second transistor T2 may be connected to the gate of the first transistor T1, and a second terminal of the second transistor T2 may be connected to the drain of the first transistor T1. The second transistor T2 may have a gate connected to the gate line GCL and may diode-connect the first transistor T1 in response to a gate signal (or first gate signal) GC[n] of the gate line GCL.

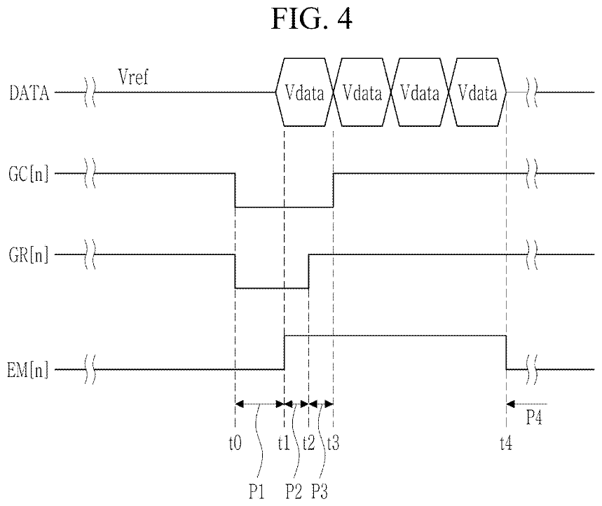

The third transistor T3 may be connected between the data line DL and the gate of the first transistor T1 to transfer the data signal of the data line DL to the gate of the first transistor T1. For example, a first terminal of the third transistor T3 may be connected to the first terminal of the second transistor T2, and a second terminal of the third transistor T3 may be connected to the data line DL. The third transistor T3 may have a gate connected to the gate line GRL and may transfer the data signal to the gate of the first transistor T1 in response to a gate signal (or, second gate signal) GR[n] of the gate line GRL. The data signal provided through the third transistor T3 may also be applied to the second terminal of the first transistor T1 during a certain period (e.g., during an initialization period P1 in FIG. 4).

The fourth transistor T4 may control transfer of the drive current from the first transistor T1 to the light emitting element ED. The first transistor T1, the fourth transistor T4, and the light emitting element ED may be connected in series between the voltage lines VDDL and VSSL. The connection order of the first transistor T1, the fourth transistor T4, and the light emitting element ED is not limited to an example shown in FIG. 2. For example, as shown in FIG. 2, a first terminal of the fourth transistor T4 may be connected to the second terminal of the first transistor T1, and a second terminal of the fourth transistor T4 may be connected to a first terminal (e.g., anode) of the light-emitting element ED. A second terminal (e.g., cathode) of the light-emitting element ED may be connected to the voltage line VSSL. The fourth transistor T4 may have a gate connected to the gate line EML and may transfer the drive current of the first transistor T1 to the light emitting element ED in response to a gate signal (or third gate signal) EM[n] of the gate line EML.

An operation of the pixel PX shown in FIG. 2 is described with reference to FIG. 4 to FIG. 8.

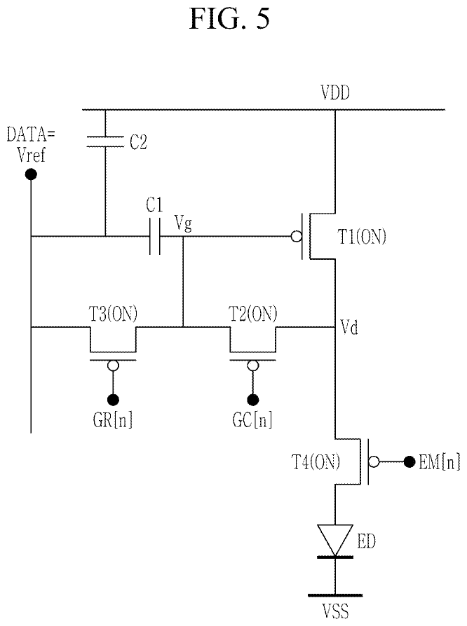

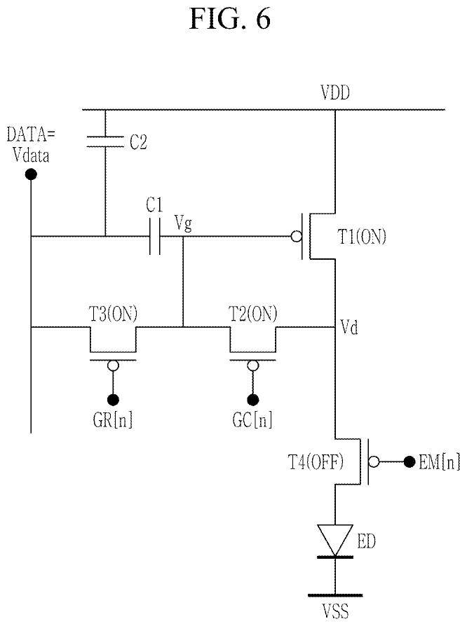

FIG. 4 illustrates a timing diagram of signals applied to a pixel of a display device according to an embodiment, and FIG. 5, FIG. 6, FIG. 7, and FIG. 8 illustrate operations of a pixel according to timing shown in FIG. 4.

Referring to FIG. 4 and FIG. 5, at time to, while the gate signal EM[n] is at the low level, the gate signals GC[n] and GR[n] may be switched from the high level to the low level so that initialization may be performed during a first period P1 (or initialization period). In the first period P1, the second and the third transistors T2 and T3 may be turned on while the transistor T4 is keeping its turn-on state, and the data signal may have the reference voltage Vref (or first voltage) rather than the data voltage Vdata representing grayscale. The transistors T2 and T3 may transfer the reference voltage Vref to a node at which the first and the second capacitors C1 and C2 are connected to the data line DL, and to the gate and the drain of the first transistor T1. Thus, a voltage Vr at the node (e.g., the node between the first terminal of the first capacitor C1 and the second terminal of the second capacitor C2), a gate voltage Vg of the first transistor T1, and a drain voltage Vd of the first transistor T1 (or an anode voltage of the light emitting device ED) may be initialized to the reference voltage Vref.

Referring to FIG. 4 and FIG. 6, at time t1, a second period P2 may begin during which the data signal may be switched from the reference voltage Vref to the data voltage Vdata to be written to the pixel PX. During the second period P2, the gate signal EM[n] may switch to the high level, which turns off the fourth transistor T4, and the data voltage Vdata representing the grayscale may be applied as the data signal. Thus, during the second period P2, the voltage Vr at the node may change to the data voltage Vdata.

Referring to FIG. 4 and FIG. 7, at time t2, a third period P3 (or data write period) may begin to compensate for a threshold voltage Vth of the first transistor T1 while applying the data voltage Vdata to the pixel PX. During the third period P3, the gate signal GR[n] may be switched to the high level, causing the transistor T3 to turn off. Because the third and the fourth transistors T3 and T4 are turned off in the third period P3, a gate-source voltage Vgs of the diode-connected first transistor T1 may change to the threshold voltage Vth of the first transistor T1. Therefore, a voltage between the gate voltage Vg and the drain voltage Vd of the first transistor T1 may become a voltage VDD+Vth, which is equal to the drive voltage VDD plus the threshold voltage Vth of the first transistor T1. During the third period P3, the voltage Vr of the node may be maintained at the data voltage Vdata. Therefore, the voltage VDD+Vth-Vdata may be stored in the first capacitor C1 and the voltage VDD-Vdata may be stored in the second capacitor C2. Through this, the threshold voltage Vth may be reflected in the gate voltage Vg of the first transistor T1 by the diode-connection of the first transistor T1 during the third period P3 such that the threshold voltage Vth can be compensated.

Referring to FIG. 4 and FIG. 8, at time t3, the gate signal GC[n] may be switched to the high level to turn off the transistor T3. While the gate signals GC[n] GR[n], and EM[n] are at the high level, a data voltage of a next pixel row may be applied to the data line DL. Then, at time t4, a fourth period P4 (or light emitting period) may begin to emit light from the pixel PX. During the fourth period P4, the gate signal EM[n] may be switched to the low level to allow the light emitting element ED to emit light. During the fourth period P4, the reference voltage Vref may be transferred to the data line DL so that the voltage Vr of the node is changed to the reference voltage Vref, allowing the gate voltage Vg of the first transistor T1 to be changed to VDD+Vth+(Vref−Vdata) by the first capacitor C1. Thus, the gate-source voltage Vgs of the first transistor T1 may become Vth+(Vref−Vdata), and the drive current Idata shown in Equation 1 may flow through the drain of the first transistor T1. As such, the drive current Idata supplied to the light-emitting element ED may be determined by the data voltage Vdata without being affected by the threshold voltage Vth of the first transistor T1. Accordingly, the variation of the threshold voltages in the pixels PX present in a display area (e.g., 110 in FIG. 1) can be compensated, and the brightness uniformity of the image can be improved.

$$Idata = \frac{β}{2} {( V gs - V th )}^{2} = \frac{β}{2} {( V th + ( V ref - V data ) - V th )}^{2} = \frac{β}{2} {( V ref - V data )}^{2} \qquad \underline{Equation 1}$$

In Equation 1, β is a constant value.

A gate driver (e.g., 120 in FIG. 1) may sequentially provide the gate signals GR[n] and GC[n]) having the low level to the plurality of gate lines GRL and GCL corresponding to respective pixel rows during a scan period (e.g., a period prior to time t4 in FIG. 4). Thereafter, during a light emitting period (e.g., a period after time t4 in FIG. 4), the gate driver (e.g., 120 in FIG. 1) may simultaneously apply the gate signal EM[n] having the low level to the plurality of gate lines EML corresponding to the respective pixel rows, such that the plurality of pixels PX of the display area (e.g., 110 in FIG. 1) can emit light at the same time. This driving method may be called as simultaneous emission.

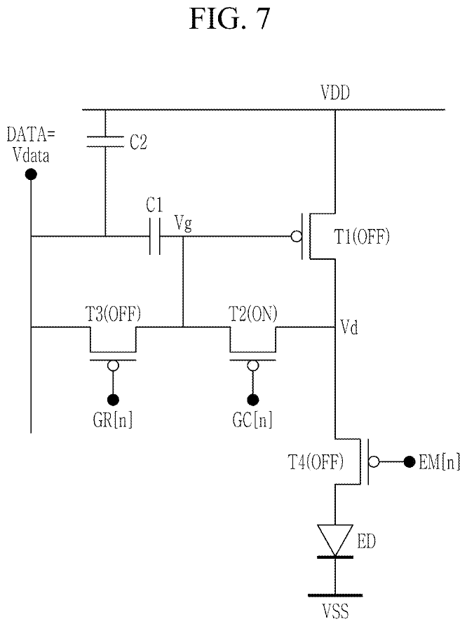

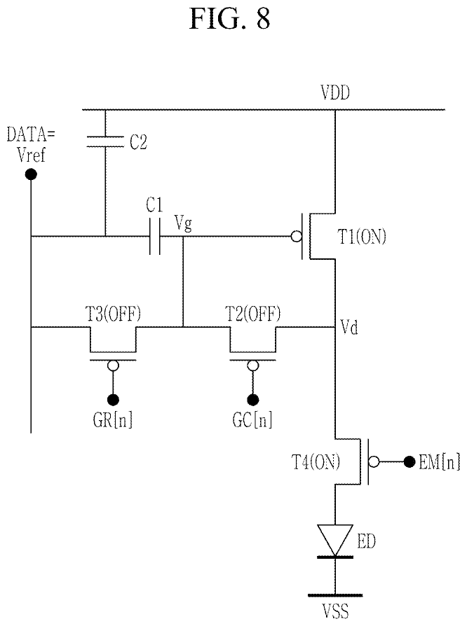

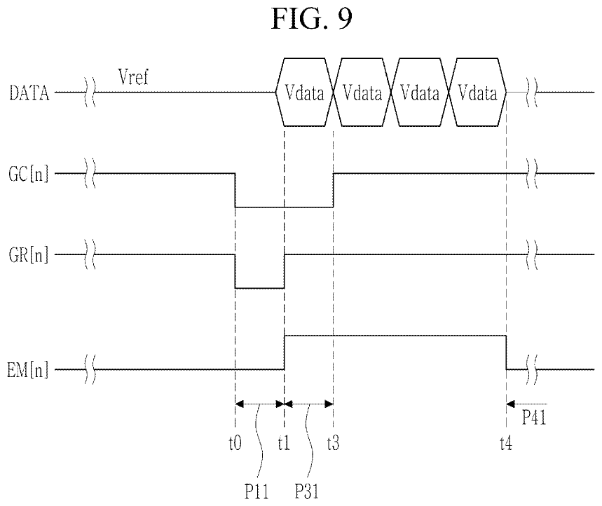

FIG. 9 is a timing diagram of signals applied to a pixel of a display device, according to an embodiment.

Referring to FIG. 2 and FIG. 9, unlike an embodiment described with reference to FIG. 4, a period during which a data signal is switched from a reference voltage Vref to a data voltage Vdata may be omitted. In this case, at time t0, while a gate signal EM[n] is at a low level, gate signals GC[n] and GR[n] may be switched from a high level to the low level, so that a voltage Vr at a node and a gate voltage Vg and drain voltage Vd of a first transistor T1 may be initialized to a reference voltage Vref by the reference voltage Vref of the data signal during a period P11. Then, at time t1, the gate signals GR[n] and EM[n] may be switched to the high level to turn off a third transistor T3 and a fourth transistor T4, and the data signal may be changed to a data voltage Vdata. Thus, during a period P31 starting at time t1, the voltage Vr at the node may be changed to the data voltage Vdata, and a gate-source voltage Vgs of the diode-connected first transistor T1 may be changed to a threshold voltage Vth of the first transistor T1, so that a voltage VDD+Vth−Vdata may be stored in a first capacitor C1. Next, at time t3, the gate signal GC[n] may be switched to the high level to turn off the third transistor T3, and a data voltage corresponding to a next pixel row may be applied to a data line DL. Next, at time t4, the gate signal EM[n] may be switched to the low level, allowing the light emitting element ED to emit light during a period P41.

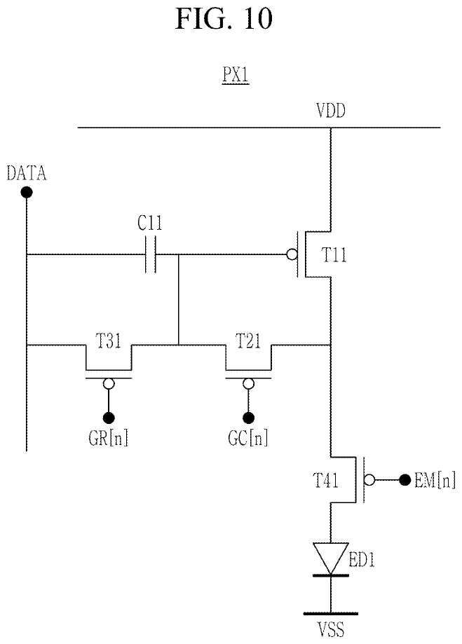

FIG. 10 is a circuit diagram illustrating a pixel of a display device according to an embodiment.

Referring to FIG. 10, a pixel PX1 may include a plurality of transistors T11, T21, T31, and T41, a first capacitor C11, and a light emitting element ED1. The pixel PX1 may be connected to a plurality of gate lines GRL, GCL, and EML, a data line DL carrying a data signal, a voltage line VDDL carrying a drive voltage VDD, and a voltage line VSSL carrying a drive voltage VSS. Connection relationships of the transistors T11, T21, T31, and T41, the first capacitor C11, and the light emitting element ED1 are the same as or similar to connection relationships of the transistors T1, T2, T3, and T4, the first capacitor C1, and the light emitting element ED described with reference to FIG. 2, so their descriptions are omitted.

Unlike a pixel PX described with reference to FIG. 2, the pixel PX1 may not include a second capacitor (C2 in FIG. 2) connected between the voltage line VDDL and the data line DL. In this case, when a voltage of the data line DL changes from a reference voltage Vref to a data voltage Vdata, voltage variation of the data line DL may be reflected to a gate of the first transistor T11 through the first capacitor C11. Other than the difference from the pixel PX described with reference to FIG. 2 (e.g., the pixel PX1 does not include a second capacitor C2), the pixel PX1 may operate in the same way as the pixel PX shown in FIG. 2.

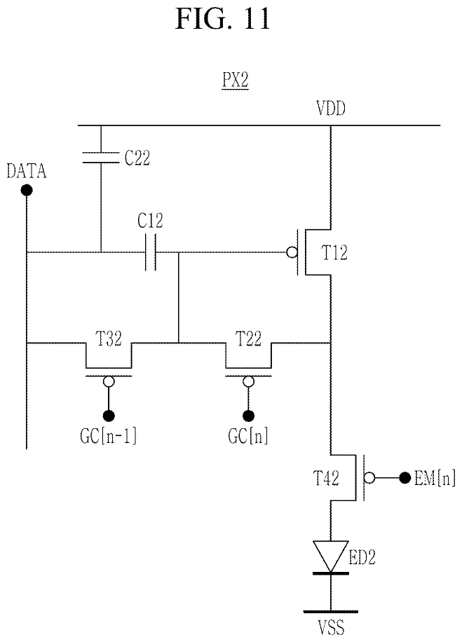

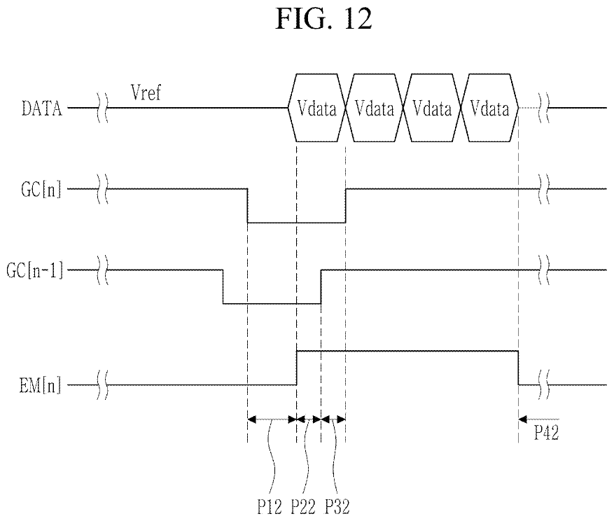

FIG. 11 is a circuit diagram illustrating a pixel of a display device according to an embodiment, and FIG. 12 illustrates a timing diagram of signals applied to a pixel shown in FIG. 11.

Referring to FIG. 11, a pixel PX2 may include a plurality of transistors T12, T22, T32, and T42, capacitors C12 and C22, and a light emitting element ED2. The pixel PX2 may be connected to a plurality of gate lines GCL and EML, a data line DL carrying a data signal, a voltage line VDDL carrying a drive voltage VDD, and a voltage line VSSL carrying a drive voltage VSS. Connection relationships of the transistors T12, T22, T32, and T42, the capacitors C12 and C22, and the light emitting element ED2 are the same as or similar to connection relationships of the transistors T1, T2, T3, and T4, the capacitors C1 and C2, and the light emitting element ED described with reference to FIG. 2, except for a gate signal applied to a gate of a third transistor T32, so their descriptions identical or similar to the descriptions about the pixel PX with reference to FIG. 2 are omitted.

Referring to FIG. 11 and FIG. 12, in the pixel PX2, the gate of the third transistor T32 may be applied with a gate signal of another pixel row. For example, the gate of the third transistor T32 may be applied with a gate signal GC[n−1] that is switched to a low level prior to a gate signal GC[n] applied to a gate of a second transistor T22. As shown in FIG. 12, the n^{th} gate signal GC[n] may be switched to the low level while the (n−1)^{th} gate signal GC[n−1] is at the low level. Thus, the pixel PX2 may operate in the same way as the pixel PX described with reference to FIG. 4 and FIG. 5 during a period P12 in which the gate signals GC[n−1], GR[n], and EM[n] have the low level, operate in the same way as the pixel PX described with reference to FIG. 4 and FIG. 6 during a period P22 in which the gate signals GC[n−1] and GR[n] have the low level and the gate signal EM[n] has the high level, operate in the same way as the pixel PX described with reference to FIG. 4 and FIG. 7 during a period P32 in which the gate signals GC[n−1] and EM[n] have the high level and the gate signal GC[n] has the low level, and operate in the same way as the pixel PX described with reference to FIG. 4 and FIG. 8 during a period P42 in which the gate signals GC[n] and GC[n−1] have the high level and the gate signal EM[n] has the low level.

As described with reference to FIG. 11 and FIG. 12, the gate of the third transistor T31 in the pixel PX1 shown in FIG. 10 may also be applied with the gate signal GC[n−1] instead of the gate signal GR[n].

In such a case, as the gate signal GR[n] described with reference to FIG. 2 to FIG. 8 may not be used, it is possible to reduce the number of gate drive circuits for generating the gate signals.

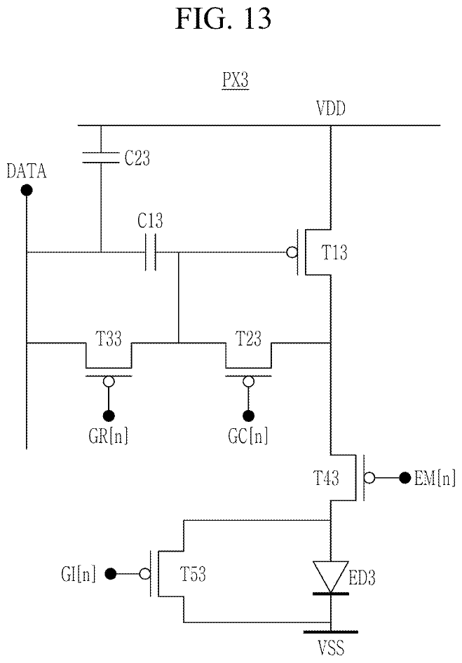

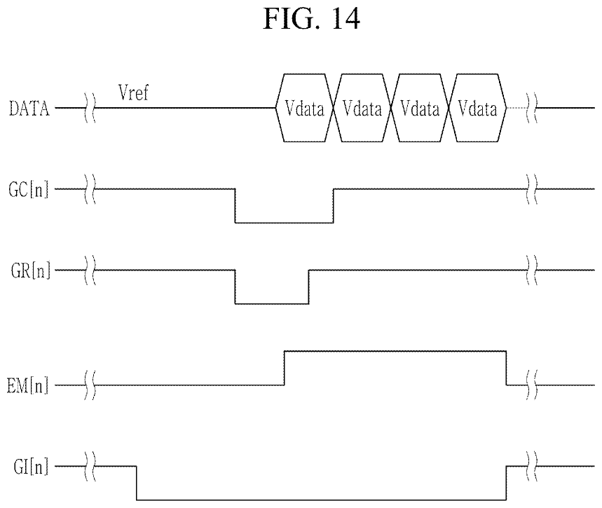

FIG. 13 is a circuit diagram illustrating a pixel of a display device according to an embodiment, and FIG. 14 illustrates a timing diagram of signals applied to a pixel shown in FIG. 13.

Referring to FIG. 13, a pixel PX3 may include a plurality of transistors T13, T23, T33, T43, and T53, capacitors C13 and C23, and a light emitting element ED3. The pixel PX3 may be connected to a plurality of gate lines GRL, GCL, and EML, a gate line carrying a gate signal GI[n], a data line DL carrying a data signal, a voltage line VDDL carrying a drive voltage VDD, and a voltage line VSSL carrying a drive voltage VSS. Connection relationships of the transistors T13, T23, T33, and T43, the capacitors C13 and C23, and the light emitting element ED3 are the same as or similar to connection relationships of the transistors T1, T2, T3, and T4, the capacitors C1 and C2, and the light emitting element ED described with reference to FIG. 2, so their descriptions identical or similar to the descriptions about the pixel PX with reference to FIG. 2 are omitted.

The pixel PX3 may include a fifth transistor T53 connected in parallel to the light-emitting element ED3, and a gate signal (or fourth gate signal) GI[n] may be applied to the gate of the fifth transistor T53. For example, a first terminal and a second terminal of the fifth transistor T53 may be connected to a first terminal (e.g., anode) and a second terminal (e.g., cathode) of the light-emitting element ED3, respectively.

Referring to FIG. 13 and FIG. 14, the gate signal GI[n] may be maintained at a low level before the gate signal EM[n] is switched to the low level, and may be switched to a high level when the gate signal EM[n] is switched to the low level. In this case, after the pixel PX3 emits light, the anode of the light-emitting element ED may be initialized to the drive voltage VSS by the fifth transistor T53 that is turned on in response to the low level of the gate signal GI[n]. As such, by separating a path for initializing the anode of the light-emitting element ED3 from a path for writing data, the anode of the light-emitting element ED3 can be maintained in an initialized state during a data writing period (i.e., driving period) of a display device.

As described with reference to FIG. 13 and FIG. 14, the fifth transistor T53 may also be connected in parallel to the light emitting element ED, ED1, or ED2 of the pixel PX, PX1, or PX2 shown in FIG. 2, FIG. 10, or FIG. 11, respectively.

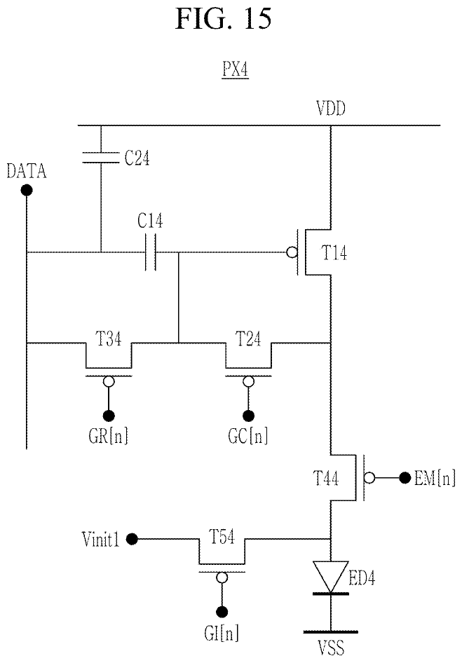

FIG. 15 is a circuit diagram illustrating a pixel of a display device according to an embodiment.

Referring to FIG. 15, a pixel PX4 may include a plurality of transistors T14, T24, T34, T44, and T54, capacitors C14 and C24, and a light emitting element ED4. The pixel PX4 may be connected to a plurality of gate lines GRL, GCL, and EML, a gate line carrying a gate signal GI[n], a data line DL carrying a data signal, a voltage line VDDL carrying a drive voltage VDD, and a voltage line VSSL carrying a drive voltage VSS. Connection relationships of the transistors T14, T24, T34, and T44, the capacitors C14 and C24, and the light emitting element ED4 are the same as or similar to connection relationships of the transistors T1, T2, T3, T4, the capacitors C1, C2, and the light emitting element ED described with reference to FIG. 2, so their descriptions identical or similar to the descriptions about the pixel PX with reference to FIG. 2 are omitted.

The fifth transistor T54 may be connected between a voltage line carrying an initialization voltage (or second voltage) Vinit1 and a first terminal of the light-emitting element ED4 (e.g., anode), and a gate of the fifth transistor T54 may be applied with the gate signal GI[n]. For example, a first terminal of the fifth transistor T54 may be connected to the voltage line carrying the initialization voltage Vinit1, and a second terminal of the fifth transistor T54 may be connected to the anode of the light emitting element ED4. The initialization voltages Vinit1 applied to light emitting elements ED4, that emit different colors from each other, through the fifth transistors T54 may be different from each other. For example, the initialization voltage Vinit1 that is applied to the first terminal of the transistor T54 connected to the light emitting element ED4 emitting red, the initialization voltage Vinit1 that is applied to the first terminal of the transistor T54 connected to the light emitting element ED4 emitting green, and the initialization voltage Vinit1 that is applied to the first terminal of the transistor T54 connected to the light emitting element ED4 emitting blue may be different from each other. Because the voltages corresponding to the same grayscale may vary depending on color of the light-emitting elements ED4, the initialization voltage Vint1 may be set differently for each color of the light-emitting element ED4, thereby preventing smearing that may occur at low grayscale.

As described with reference to FIG. 15, the fifth transistor T54 may also be connected between the first terminal (e.g., anode) of the light emitting element ED, ED1, or ED2 of the pixel PX, PX1, or PX2 shown in FIG. 2, FIG. 10, or FIG. 11 and the voltage line carrying the initialization voltage Vinit1.

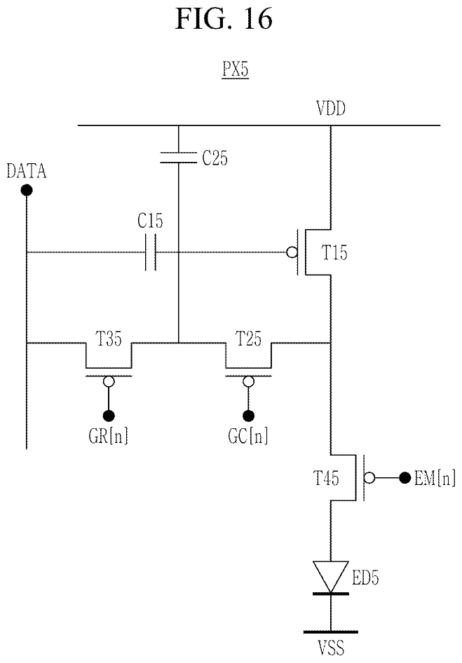

FIG. 16 is a circuit diagram illustrating a pixel of a display device according to an embodiment.

Referring to FIG. 16, a pixel PX5 may include a plurality of transistors T15, T25, T35, and T45, capacitors C15 and C25, and a light emitting element ED5. The pixel PX5 may be connected to a plurality of gate lines GRL, GCL, and EML, a data line DL carrying a data signal, a voltage line VDDL carrying a drive voltage VDD, and a voltage line VSSL carrying a drive voltage VSS. Connection relationships of the transistors T15, T25, T35, and T45, the first capacitor C15, and the light emitting element ED5 are the same as or similar to connection relationships of the transistors T1, T2, T3, and T4, the first capacitor C1, and the light emitting element ED described with reference to FIG. 2, so their descriptions identical or similar to the descriptions about the pixel PX with reference to FIG. 2 are omitted.

The pixel PX5 may include a second capacitor C25 connected between the voltage line VDDL and a gate of the first transistor T15. In this case, a gate voltage of the first transistor T15 when the gate signal EM[n] is switched to a high level may be given as shown in Equation 2. Thus, the threshold voltage Vth of the first transistor T15 can be compensated.

$$V g = V DD + V th + ( V ref - V data ) \frac{{C}_{1}}{{C}_{1} + {C}_{2}} \qquad \underline{Equation 2}$$

In Equation 2, C1 and C2 are capacitances of the capacitors C15 and C25, respectively.

As described with reference to FIG. 16, The pixel PX2, PX3, or PX4 shown in FIG. 11, FIG. 13, FIG. 15 may include the capacitor C22, C23, or C24 connected between the voltage line VDDL and the gate of the first transistor T12, T13, or T14.

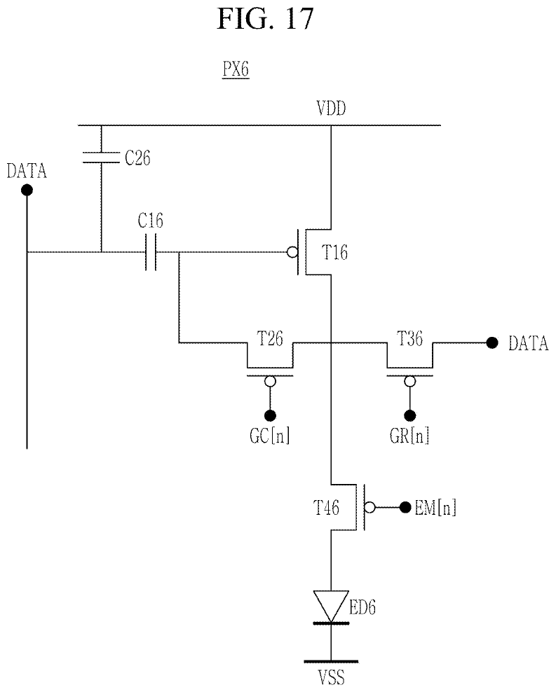

FIG. 17 is a circuit diagram illustrating a pixel of a display device according to an embodiment.

Referring to FIG. 17, a pixel PX6 may include a plurality of transistors T16, T26, T36, and T46, capacitors C16 and C26, and a light emitting element ED6. The pixel PX6 may be connected to a plurality of gate lines GRL, GCL, and EML, a data line DL carrying a data signal, a voltage line VDDL carrying a drive voltage VDD, and a voltage line VSSL carrying a drive voltage VSS. Connection relationships of the transistors T16, T26, and T46, the capacitors C16 and C26, and the light-emitting element ED6 are the same as or similar to connection relationships of the transistors T1, T2, and T4, the capacitors C1 and C2, and the light emitting element ED described with reference to FIG. 2, so their descriptions identical or similar to the descriptions about the pixel PX with reference to FIG. 2 are omitted.

The pixel PX6 may include a third transistor T36 connected between a second terminal (e.g., drain) of the first transistor T16 and the data line DL, and a gate signal GR[n] may be applied to a gate of the third transistor T36. For example, a first terminal of the third transistor T36 may be connected to the second terminal of the first transistor T16, and a second terminal of the third transistor T36 may be connected to the data line DL. In this case, the pixel PX6 may operate the same as described with reference to FIG. 4 to FIG. 8.

As described with reference to FIG. 17, the pixel PX, PX1, PX2, PX3, PX4, or PX5 shown in FIG. 2, FIG. 10, FIG. 11, FIG. 13, FIG. 15, or FIG. 16 may include the third transistor T3, T31, T32, T33, T34, or T35 connected between the second terminal of the first transistor T1, T11, T12, T13, T14, T15, or T15 and the data line DL.

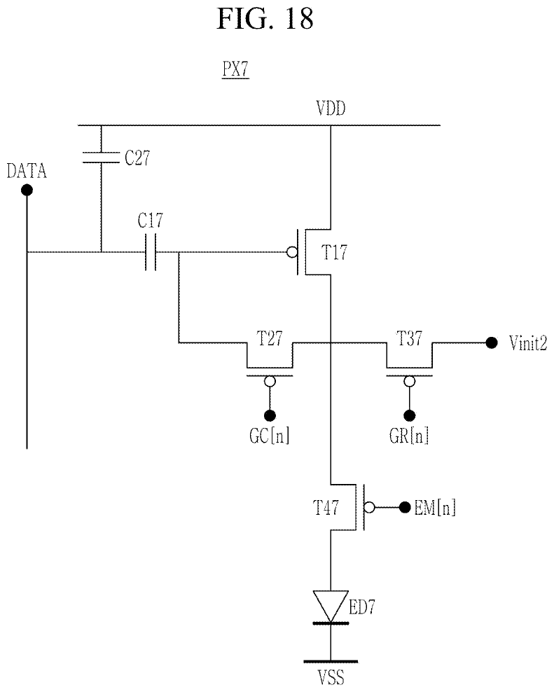

FIG. 18 is a circuit diagram illustrating a pixel of a display device according to an embodiment.

Referring to FIG. 18, a pixel PX7 may include a plurality of transistors T17, T27, T37, and T47, capacitors C17 and C27, and a light emitting element ED7. The pixel PX7 may be connected to a plurality of gate lines GRL, GCL, and EML, a data line DL carrying a data signal, a voltage line VDDL carrying a drive voltage VDD, and a voltage line VSSL carrying a drive voltage VSS. Connection relationships of the transistors T17, T27, and T47, the capacitors C17 and C27, and the light emitting element ED7 are the same as or similar to the connection relationships of the transistors T1, T2, and T4, the capacitors C1 and C2, and the light emitting element ED described with reference to FIG. 2, so their descriptions identical or similar to the descriptions about the pixel PX with reference to FIG. 2 are omitted.

The pixel PX7 may include a third transistor T37 connected between a second terminal (e.g., drain) of the first transistor T16 and a voltage line carrying an initialization voltage (or second voltage) Vinit2, and a gate signal GR[n] may be applied to a gate of third transistor T37. The initialization voltage Vinit2 may be supplied from a voltage line other than the data line DL. For example, a first terminal of the third transistor T37 may be connected to the voltage line carrying the initialization voltage Vinit2, and a second terminal of the third transistor T37 may be connected to the second terminal of the first transistor T17. The pixel PX7 may operate the same as described with reference to FIG. 4 to FIG. 8. In this case, the anode of the light emitting element ED7 may be initialized with the initialization voltage Vinit2.

As described with reference to FIG. 18, the pixel PX, PX1, PX2, PX3, PX4, or PX5 shown in FIG. 2, FIG. 10, FIG. 11, FIG. 13, FIG. 15, or FIG. 16 may include the third transistor T3, T31, T32, T33, T34, or T35 connected between the second terminal of the first transistor T1, T11, T12, T13, T14, T15, or T15 and the voltage line carrying the initialization voltage Vinit2.

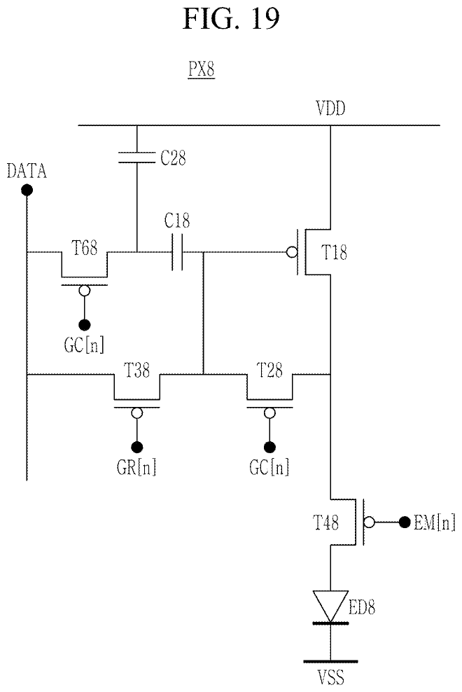

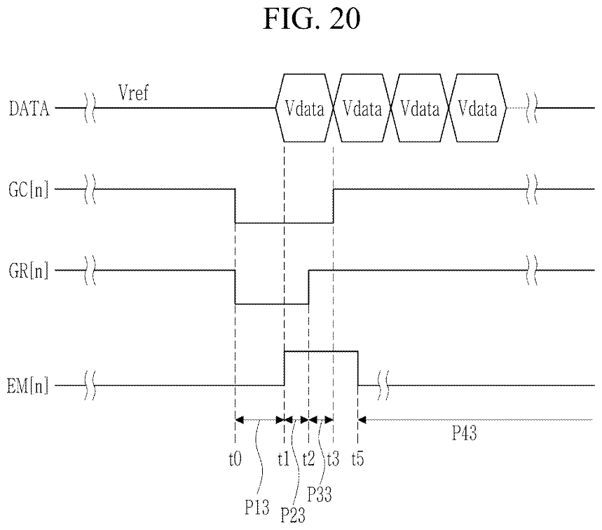

FIG. 19 is a circuit diagram illustrating a pixel of a display device according to an embodiment, and FIG. 20 illustrates a timing diagram of signals applied to a pixel shown in FIG. 19.

Referring to FIG. 19, a pixel PX8 may include a plurality of transistors T18, T28, T38, T48, and T68, capacitors C18 and C28, and a light emitting element ED8. The pixel PX8 may be connected to a plurality of gate lines GRL, GCL, and EML, a data line DL carrying a data signal, a voltage line VDDL carrying a drive voltage VDD, and a voltage line VSSL carrying a drive voltage VSS. Connection relationships of the transistors T18, T28, T38, and T48, the capacitors C18 and C28, and the light emitting element ED8 are same as or similar to connection relationships of the transistors T1, T2, T3, and T4, the capacitors C1 and C2, and the light emitting element ED described with reference to FIG. 2, so their descriptions identical or similar to the descriptions about the pixel PX with reference to FIG. 2 are omitted.

The pixel PX8 may include a sixth transistor T68 connected between the data line DL and a first terminal of the first capacitor C18, and a gate signal may be applied to a gate of the sixth transistor T68. The gate signal applied to the gate of sixth transistor T68 may be the same as a gate signal GC[n] applied to a gate of second transistor T28. However, the present disclosure is not limited thereto. For example, the gate signal applied to the gate of the sixth transistor T68 may be a gate signal different from the gate signal GC[n]. A first terminal of the sixth transistor T68 may be connected to the data line DL, and a second terminal of the sixth transistor T68 may be connected to the first terminal of the first capacitor C18.

Referring to FIG. 20, during periods P13, P23, and P33, the pixel PX8 may operate in the same as during periods P1, P2, and P3 described with reference to FIG. 4. Next, at time t3, in response to a high level of the gate signal GC[n], the sixth transistor T68 may be turned off and disconnect the first capacitor C18 from the data line DL. Because of the turn-off of the sixth transistor T68, voltages stored in the first and the second capacitors C18 and C28 of the pixel PX8 may not be affected even if a data voltage corresponding to another pixel row is applied to the data line DL. Therefore, irrespective of transmission of a data voltage for another pixel row to the data line DL after the time t3, a gate signal EM[n] may be switched to the low level at time t5 so that the pixel PX8 can emit light during a period P43.

A gate driver (e.g., 120 in FIG. 1) may provide the gate signals GR[n], GC[n], and EM[n] having the low level sequentially to a plurality of gate lines GRL, GCL, and EML during a scan period (a period prior to time t4 in FIG. 4), thereby sequentially writing data voltages Vdata to a plurality of pixel rows and sequentially emitting the plurality of pixel rows. This driving method may be called progressive emission.

As described with reference to FIG. 19 and FIG. 20, the pixel PX, PX1, PX2, PX3, PX4, PX5, PX6, or PX7 shown in FIG. 2, FIG. 10, FIG. 11, FIG. 13, FIG. 15, FIG. 16, FIG. 17, or FIG. 18 may include the sixth transistor T68 connected between the data line DL and the capacitor C2, C21, C22, C23, C24, C24, C25, C25, C26, or C27.

According to the embodiments described above, even if a variation of the threshold voltage exists in the plurality of pixels of the display area (e.g., 110 of FIG. 1), the threshold voltage is not reflected in the driving current supplied to the light-emitting element of each pixel. Accordingly, the variation in threshold voltages may be compensated. Furthermore, each pixel PX uses a relatively small number of transistors, and the display device uses a relatively small number of gate wires (or gate driving circuits), which can reduce the cost of manufacturing the display device and improve the resolution of the display device.

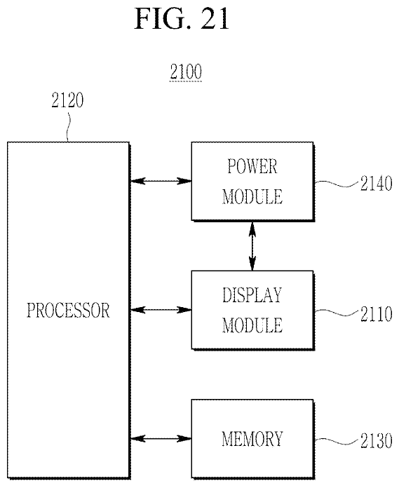

FIG. 21 is a block diagram illustrating an electronic device according to an embodiment.

Referring to FIG. 21, an electronic device 2100 may include a display module 2110, a processor 2120, a memory 2130, and a power module 2140.

The processor 2120 may include at least one of a central processing unit (CPU), an application processor (AP), a graphics processing unit (GPU), a communication processor (CP), an image signal processor (ISP), and a controller.

The memory 2130 may store data information for an operation of the processor 2120 or the display module 2110. When the processor 2120 executes an application stored in the memory 2130, an image data signal and/or an input control signal may be transmitted to the display module 2110, and the display module 2110 may process the provided signals to display the image through a display screen.

The power module 2140 may include a power supply module such as a power adapter or a battery unit, and a power conversion module that converts the power supplied from the power supply module to generate power for an operation of the electronic device 2100.

At least one of the components of the electronic device 2100 may be included in the display device according to the embodiments described above. In addition, some of individual modules included in one module functionally may be included in the display device, and others may be provided separately from the display device. For example, the display device may include the display module 2110, and the processor 2120, the memory 2130, and the power module 2140 may be provided in the form of other devices within the electronic device 2100 that are not the display device.

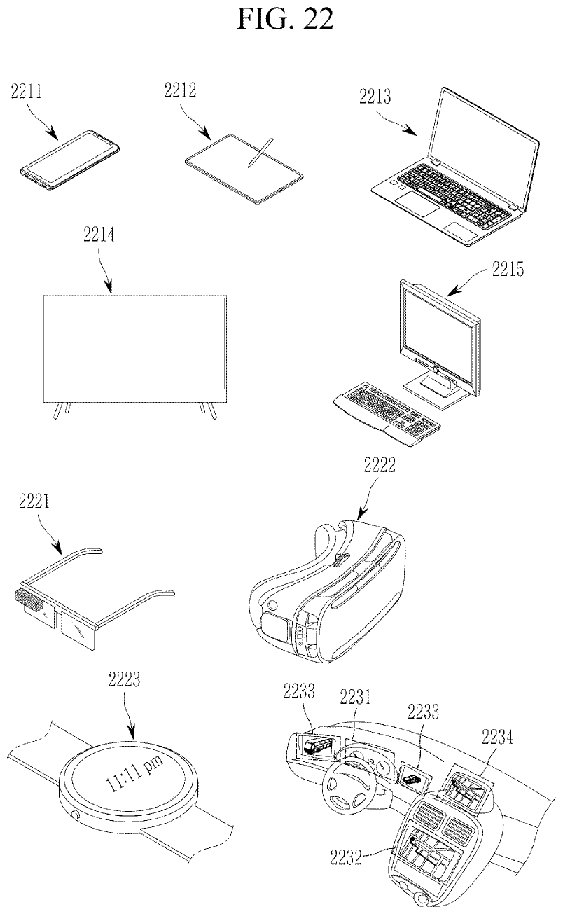

FIG. 22 is a schematic diagram of electronic devices according to various embodiments.

Referring to FIG. 22, various electronic devices to which a display device is applied include image display electronic devices such as a smartphone 2211, a tablet computer 2212, a laptop 2213, a television 2214, and a monitor 2215, wearable electronic devices including displays modules such as smart glasses 2221, a head-mounted display 2222, and a smart watch 2223, and automotive electronic devices including display modules such as an instrument panel 2231, a center fascia 2232, a center information display (CID) 2233 disposed on a dashboard, and a room mirror display 2234.

Although an embodiment has been described in detail above, the scope of the present disclosure is not limited thereto, and various modifications and improvements made by a person of an ordinary skill in the art using the technical feature of the present disclosure defined in the following claims also fall within the scope of the present disclosure.

What is claimed is:

1. A display device comprising:
a pixel;
a gate driver configured to output a first gate signal, a second gate signal, and a third gate signal to the pixel; and
a data driver configured to output a data signal to the pixel, the data signal having either a reference voltage or a data voltage,
wherein the pixel comprises:
a first transistor connected between a first drive voltage line configured to supply a first drive voltage and a second drive voltage line configured to supply the second drive voltage;
a first capacitor comprising a first terminal configured to receive the data signal and a second terminal connected to a gate of the first transistor;
a second transistor connected between the gate of the first transistor and a drain of the first transistor, and including a gate configured to receive the first gate signal;
a third transistor comprising a first terminal connected to either the gate of the first transistor or the drain of the first transistor, a second terminal configured to receive a first voltage, and a gate configured to receive the second gate signal;
a fourth transistor connected in series with the first transistor between the first drive voltage line and the second drive voltage line, and comprising a gate configured to receive the third gate signal; and
a light emitting element connected in series with the first transistor and the fourth transistor between the first drive voltage line and the second drive voltage line.

2. The display device of claim 1, wherein the pixel further comprises a second capacitor connected between the first drive voltage line and the first terminal of the first capacitor.

3. The display device of claim 1, wherein the pixel further comprises a second capacitor connected between the first drive voltage line and the gate of the first transistor.

4. The display device of claim 1, wherein the pixel further comprises a fifth transistor connected to the light emitting element in parallel and comprising a gate configured to receive a fourth gate signal.

5. The display device of claim 1, wherein the pixel further comprises a fifth transistor connected between an anode of the light emitting element and a signal line configured to carry a second voltage, and comprising a gate configured to receive a fourth gate signal.

6. The display device of claim 1, wherein the first terminal of the third transistor is connected to the gate of the first transistor, and
wherein the first voltage is the data signal.

7. The display device of claim 1, wherein the first terminal of the third transistor is connected to the drain of the first transistor, and
wherein the first voltage is the data signal.

8. The display device of claim 1, wherein the first terminal of the third transistor is connected to the drain of the first transistor, and
wherein the first voltage is a voltage other than the data signal.

9. The display device of claim 1, wherein the pixel further comprises a fifth transistor connected between a data line configured to carry the data signal and the first terminal of the first capacitor, and comprising a gate configured to receive a fourth gate signal.

10. The display device of claim 9, wherein the fourth gate signal is the first gate signal.

11. The display device of claim 1, wherein the second gate signal of the pixel is the first gate signal of another pixel.

12. The display device of claim 1, wherein the gate driver is further configured to:
output the first gate signal having an enable level, the second gate signal having the enable level, and the third gate signal having the enable level in a first period,
output the first gate signal having the enable level, the second gate signal having the disable level, and the third gate signal having the disable level in a second period, and
output the first gate signal having the disable level, the second gate signal having the disable level, and the third gate signal having the enable level in a third period, and
wherein the data driver is further configured to output the data signal having the reference voltage in the first period, and output the data signal having the data voltage in the second period.

13. The display device of claim 12, wherein the gate driver is further configured to output the first gate signal having the enable level, the second gate signal having the enable level, and the third gate signal having the disable level in a fourth period between the first period and the second period, and
wherein the data driver is further configured to output a data signal having the data voltage in the fourth period.

14. An electronic device comprising:
a processor; and
a display module connected to the processor and comprising a pixel and a data line configured to carry a data signal having either a reference voltage or a data voltage,
wherein the pixel comprises:
a first transistor configured to output a drive current to a drain based on a gate-to-source voltage;
a capacitor comprising a first terminal connected to a gate of the first transistor and a second terminal configured to receive the reference voltage during an initialization period and receive the data voltage during a data writing period;
a second transistor connected between the gate of the first transistor and the drain of the first transistor, and configured to diode-connect the first transistor during the data writing period;
a third transistor configured to transfer a first voltage to either the gate of the first transistor or the drain of the first transistor during the initialization period;
a light emitting element; and
a fourth transistor configured to transfer the drive current of the first transistor to the light emitting element during a light emission period.

15. The electronic device of claim 14, wherein the first voltage is the reference voltage transferred from the data line.

16. The electronic device of claim 14, wherein the first voltage is a voltage supplied from a voltage line other than the data line.

17. The electronic device of claim 14, wherein the pixel further comprises a fifth transistor configured to transfer a second voltage to an anode of the light emitting element during the initialization period.

18. The electronic device of claim 17, wherein the second voltage is a drive voltage used to drive the first transistor.

19. The electronic device of claim 14, wherein the pixel further comprises a fifth transistor configured to disconnect a connection between the second terminal of the capacitor and the data line during the light emission period.

20. A method of driving a display device, the display device comprising a pixel including a transistor, a capacitor comprising a first terminal connected to a gate of the transistor, and a light emitting element, the method comprising:
initializing a second terminal of the capacitor, the gate and a drain of the transistor and an anode of the light emitting element;
providing a data voltage to the second terminal of the capacitor while the transistor is diode-connected; and
supplying a current of the transistor to the light emitting element while a reference voltage is provided to the second terminal of the capacitor.
